(19) United States
(12) Patent Application Publication
(10) Pub. No.: US 2012/0133193 A1
(43) Pub. Date: May 31, 2012

(54) VEHICLE SEAT

(75) Inventors: Hideyuki ABE, Toyota-shi (JP); Hiroshi MIZOBATA, Seto-shi (JP)

(73) Assignee: TOYOTA BOSHOKU KABUSHIKI KAISHA, Aichi-ken (JP)

(21) Appl. No.: 13/292,467

(22) Filed: Nov. 9, 2011

(30) Foreign Application Priority Data
Nov. 30, 2010 (JP) 2010-266762

(51) Int. Cl. B60N 2/44; B60N 2/68; B60N 2/58

(52) U.S. Cl. 297/452.55

(57) ABSTRACT

A support member has a first part that abuts against a frame member to be engaged with the frame member, and a second part to which an edge of upholstery is attached. The first part and the second part are formed at one side of the support member in a row. The first part is formed by bending a portion of the one side of the support member so as to curve toward a first side of the frame member that is different from a second side of the frame member, at which a cushioning material is arranged. The second part is formed by bending another portion of the one side of the support member so as to curve in the opposite direction from the first part and so as to protrude toward the center of the frame member.

### INCORPORATION BY REFERENCE

The disclosure of Japanese Patent Application No. 2010-266762 filed on Nov. 30, 2010 including the specification, drawings and abstract is incorporated herein by reference in its entirety.

### BACKGROUND OF THE INVENTION

1. Field of the Invention

The invention relates to a vehicle seat that includes a frame member, a cushioning material, and a support member (a member that is placed on the frame member to support the cushioning material).

2. Description of the Related Art

As a vehicle seat of this type, there is a vehicle seat that includes a seat cushion and a seat back (refer to Japanese Patent Application Publication No. 2007-22502 (JP-A-2007-22502)). The seat cushion has a frame member that constitutes a seat framework, a cushioning material that constitutes a seat exterior, and support members. Each support member is a wire rod routed in a shape obtained by successively connecting multiple “S” shapes, and placed on the frame member to elastically support the cushioning material. According to JP-A-2007-22502, multiple support members are arranged side by side on the frame member, and an end of each support member is engaged with the frame member. Next, the cushioning material is placed on the support members, and thus the cushioning material is arranged on the frame member via the support members. Then, the cushioning material is covered with upholstery, and an edge of the upholstery is brought to the back side of the frame member and attached to a lower portion of the seat. According to JP-A-2007-22502, hook members (generally J-shaped resin members) are attached to the edge of the upholstery, and the hook members are engaged with intermediate sections of the support members (S-shaped sections).

In the structure described above, each hook member is engaged with the intermediate section of the support member (S-shaped section). Therefore, a tension of the upholstery is transferred to each support member, which makes it hard for part of the support member to deflect. This may give an occupant a sense of discomfort. In other words, there is a room for improvement in the seating comfort.

### SUMMARY OF THE INVENTION

The invention provides a technique for attaching upholstery to a support member with good seating comfort maintained as much as possible.

An aspect of the invention relates to a vehicle seat including upholstery that covers a seat, a frame member that constitutes a seat framework, a cushioning material that is placed on the frame member to constitute a seat exterior and elastically support an occupant, and a support member which is a frame body, and via which the cushioning material is attached to the frame member. The cushioning material is covered with the upholstery. An edge of the upholstery is brought to a first side of the frame member that is different from a second side of the frame member, at which the cushioning material is arranged, and the edge is engaged with the support member. In the seat structure of this type, it is desirable to attach the upholstery to the support member with good seating comfort maintained as much as possible.

Therefore, in the above-described aspect, the support member includes a supporting section that is disposed at the center of the frame member and is configured to support the cushioning material, a first part that is configured to abut against the frame member to be engaged with the frame member, and a second part to which the edge of the upholstery is attached. In addition, the first part and the second part are formed at one side of the support member in a row. The first part is formed by bending a portion of the one side of the support member so as to curve toward the first side of the frame member. The second part is formed by bending another portion of the one side of the support member so as to curve in the opposite direction from the first part and so as to protrude toward the center of the frame member (The second part has such a shape that the second part is engageable with the frame member relatively firmly).

According to the vehicle seat described above, it is possible to attach the upholstery to the support member with good seating comfort maintained as much as possible.

In the vehicle seat described above, the support member described above may have a plurality of the first parts. In this vehicle seat, the support member is engaged at the multiple first parts with the frame member. Therefore, the support member is stably attached to the frame member.

In addition, an attaching member may be provided at a rear edge of the upholstery, and the upholstery may be attached to the support member via the attaching member. As described above, because the upholstery is attached to a part that is different from a seating section and that is located at the rear side portion of the support member, the upholstery is attached with high stability, and an amount by which the upholstery is drawn onto the back side of the vehicle seat is reduced.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a perspective view of a vehicle seat according to an embodiment of the invention;

FIG. 2 is an exploded perspective view of a part of a seat cushion of the vehicle seat according to the present embodiment;

FIG. 3 is a perspective view of a frame member and a support member of the vehicle seat according to the present embodiment;

FIG. 4 is a side view of the support member of the vehicle seat according to the present embodiment; and

FIG. 5 is a perspective view of the seat cushion of the vehicle seat according to the present embodiment.

### DETAILED DESCRIPTION OF EMBODIMENTS

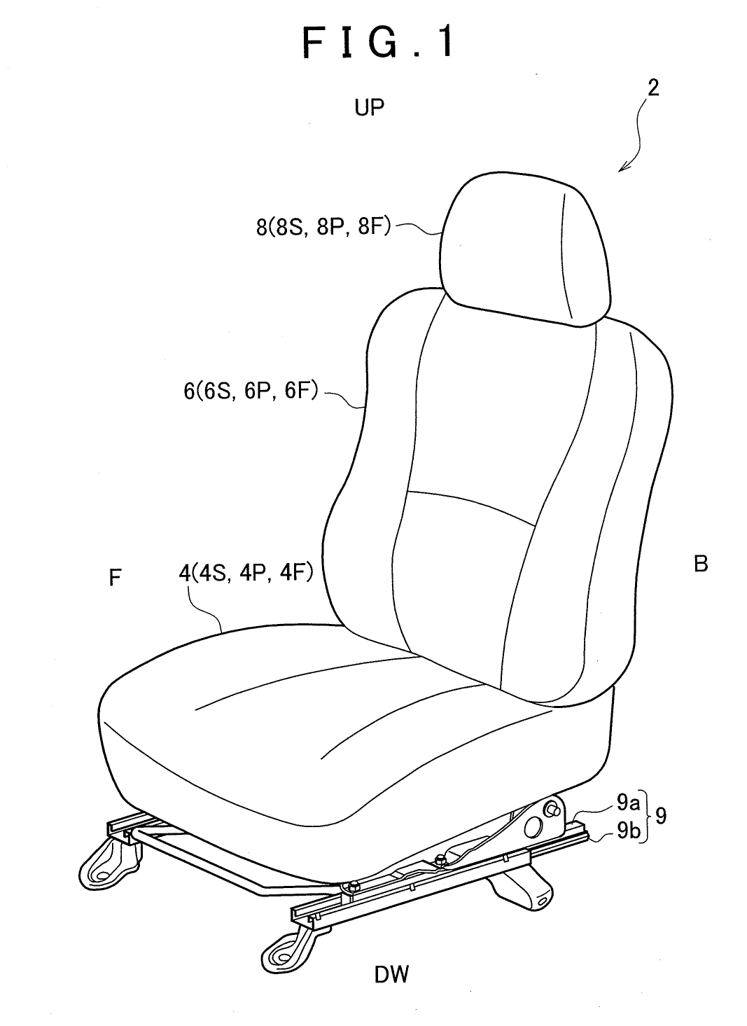

Hereafter, an embodiment of the invention will be described with reference to FIG. 1 to FIG. 5. In each drawing, the following reference symbols that denote respective directions are given as appropriate: F for the front side of a vehicle seat; B for the back side of the vehicle seat, UP for the upper side of the vehicle seat; and DW for the lower side of the vehicle seat. A vehicle seat 2 shown in FIG. 1 has seat components (a seat cushion 4, a seat back 6, and a headrest 8) and rail members 9. The seat components respectively have frame members (4F, 6F, 8F) that constitute seat frameworks, cushioning materials (4P, 6P, 8P) that constitute seat exteriors, and upholsteries 4S (4S, 6S, 8S) that cover the cushioning materials.

Each rail member 9 is used to slide the vehicle seat 2 in the vehicle longitudinal direction, and includes an upper rail 9a and a lower rail 9b (see FIG. 1). The lower rail 9b is a generally U-shaped member (in vertical cross section) that extends from the front to rear of the seat, and that is disposed on a floor of a vehicle cabin. The upper rail 9a is a generally inverted U-shaped member (in vertical cross section) that extends from the front to rear of the seat, and that is slidably installed on the lower rail 9b. In the present embodiment, the frame member 4F is fitted to upper sections of the upper rails 9a. Thus, the upper rails 9a (vehicle seat 2) is slidable with respect to the lower rails 9b in the vehicle longitudinal direction. In addition, a clearance is created between the frame member 4F and the floor of the vehicle cabin (clearance into which the edge of the upholstery 4S is drawn).

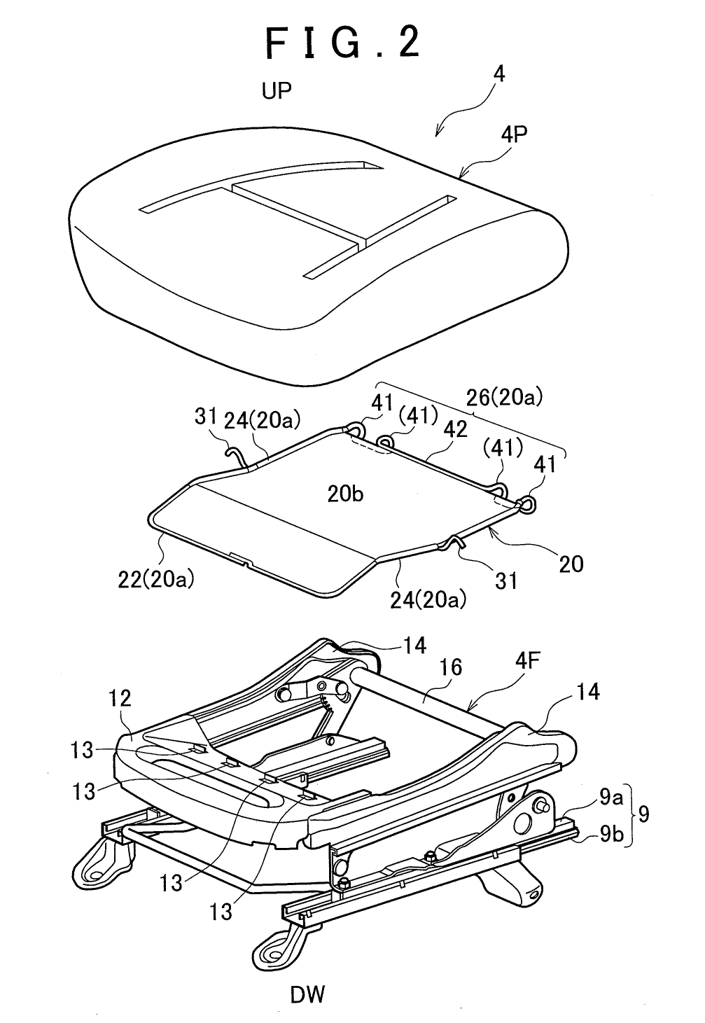

First, the seat cushion will be described. The seat cushion 4 has basic components (4F, 4P, 4S), and a support member 20 that will be described later (see FIGS. 1 and 2; details of each member will be described later). In the present embodiment, the cushioning material 4P is attached to the frame member 4F via the support member 20, and covered with the upholstery 4S. In the seat structure of this type, it is preferable to attach the upholstery 4S to the support member 20 with good seating comfort maintained. Therefore, the present embodiment provides following structures that make it possible to attach the upholstery 4S to the support member 20 with good seating comfort maintained. Hereafter, each structure will be described in detail.

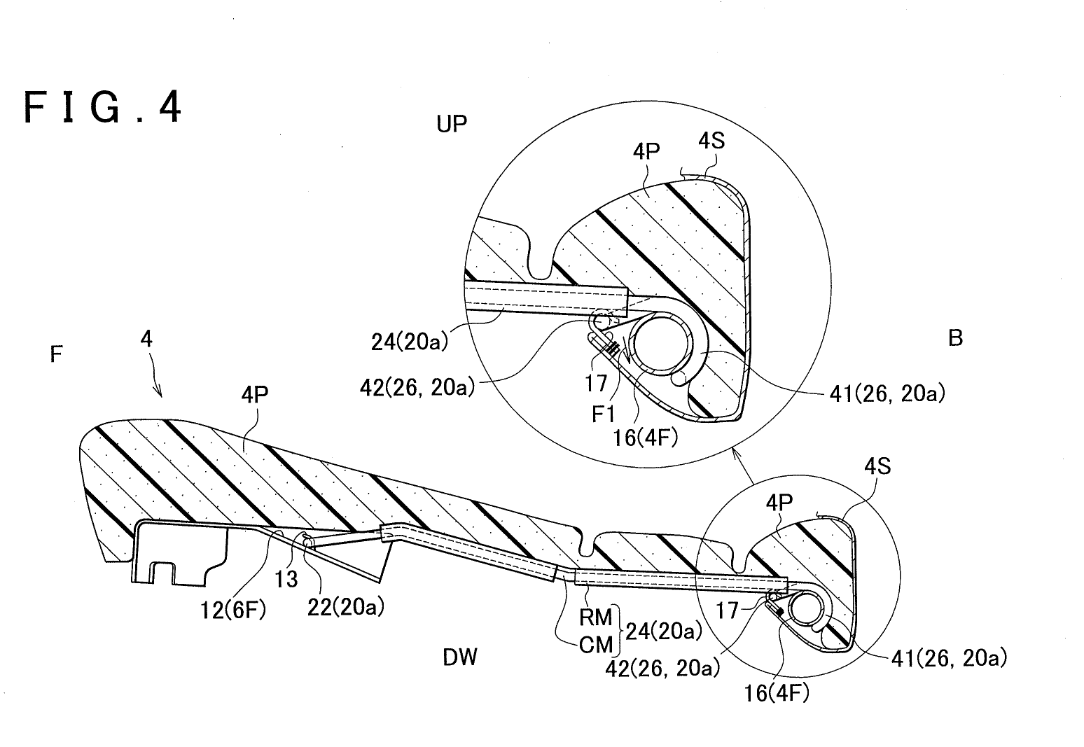

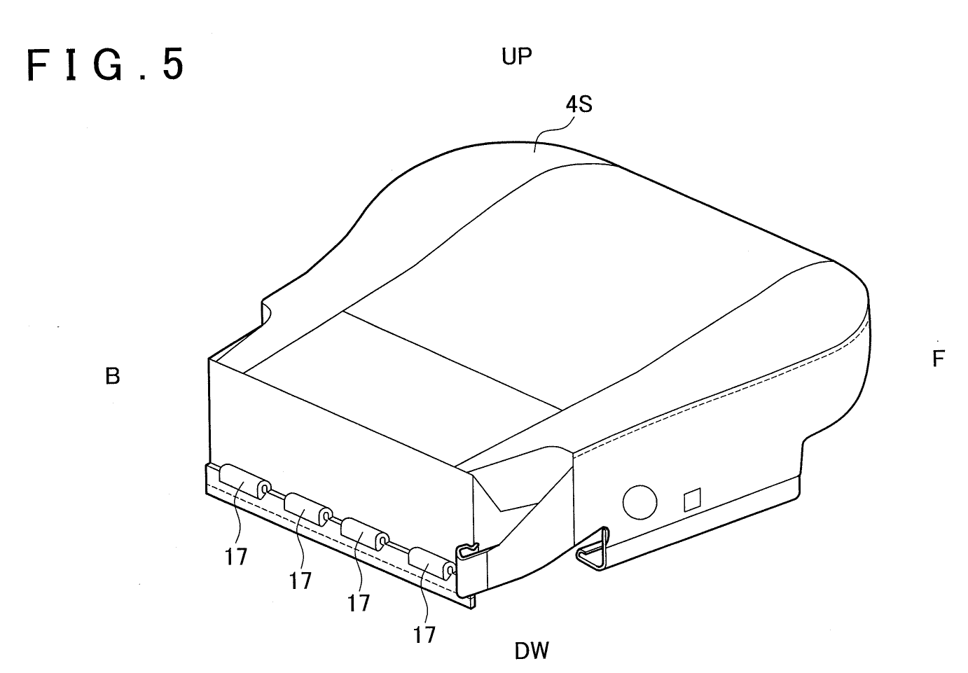

Next, the basic components of the vehicle seat according to the present embodiment will be described. The upholstery 4S is a saclike member that is able to cover the cushioning material 4P, and may be formed of fabric (woven, knit, nonwoven) or leather (natural, synthetic), for example. The cushioning material 4P is a member (in a generally rectangular shape) that constitutes a seat exterior to elastically support an occupant, and that may be made of resin material such as polyurethane foam. In the present embodiment, attaching members 17 are fitted to a rear edge of the upholstery 4S, and are engageable with the support member 20 described later (see FIGS. 4 and 5). Each attaching member 17 is a resin member formed by bending a flat plate into a generally J-shape in cross section. In the present embodiment, the multiple attaching members 17 are sewn onto the rear edge of the upholstery 4S at specified intervals.

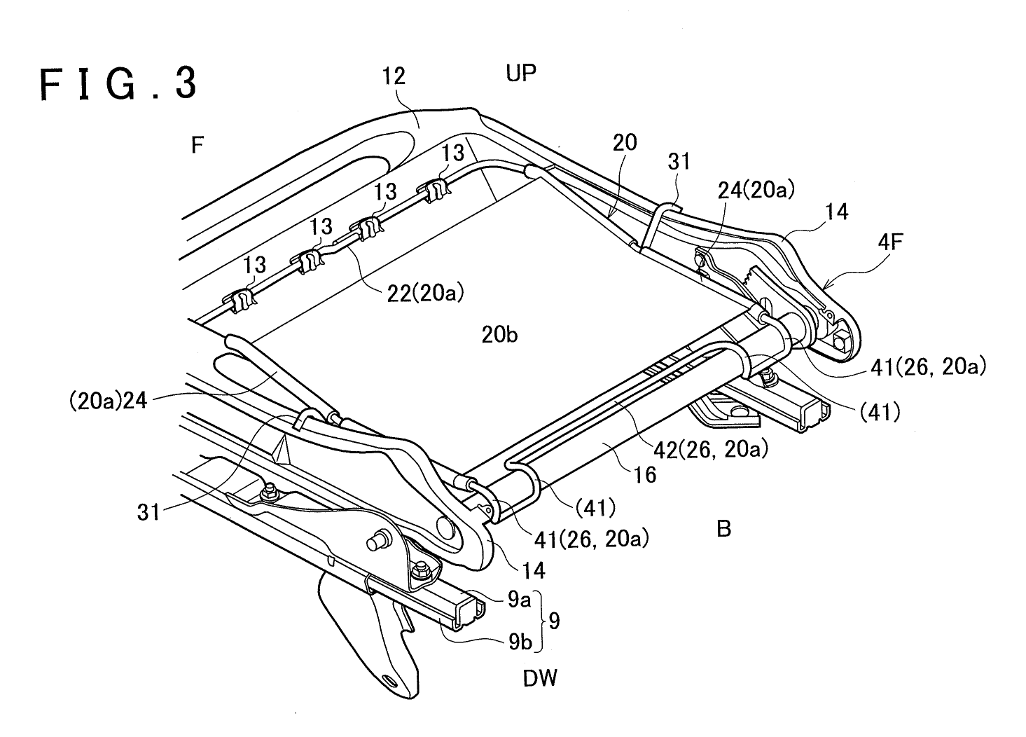

The frame member 4F has a front frame 12, a pair of side frames 14, and a rear frame 16 (see FIGS. 2 and 3). The front frame 12 is a member (planar member) that constitutes a front section of the seat cushion 4, and has a plurality of lugs 13. Each lug 13 has a generally inversed L-shape (in a side view), and is engageable with a frame body 20a described later. In the present embodiment, the multiple lugs 13 are formed so as to project from an upper surface (inclined surface) of the front frame 12, at specified intervals. The paired side frames 14 are planar members that constitute the side portions of the seat cushion 4, and disposed at seat side sections so as to face each other. The rear frame 16 is a rod member that reinforces a rear portion of the frame member 4F, and is disposed between the side frames 14 to connect the side frames 14 to each other.

Next, the support member will be described. The support member 20 is placed on the frame member 4F to support the cushioning material 4P, and has a frame body 20a, a supporting section (sheet body 20b), engagement sections 31, and other parts described later (first parts 41 and second part 42) (see FIGS. 2 to 4). In the present embodiment, the parts described later (first parts 41 and second part 42) are formed at one side of the support member 20 in a row. The support member 20 is engaged at the first parts 41 with the frame member 4F, and the edge of the upholstery 4S (attaching members 17) is engaged with the second part 42 of the support member 20.

Next, the frame body will be described. The frame body 20a is a member that is able to secure the sheet body 20b under tension, and has the first parts 41 and the second part 42 that will be described later (see FIGS. 2 to 4). The frame body 20a has a shape that follows the geometry of the frame member 4F (generally rectangular in the present embodiment) when the occupant is seated. The frame body 20a has a slightly smaller dimension than the frame member 4F, and is fitted at the center of the frame member 4F. The frame body 20a according to the present embodiment is a frame member that has a space at its center, and has a front frame section 22, a pair of side frame sections 24, a rear frame section 26, and engagement sections 31. The front frame section 22 is a front part of the frame body 20a, and located in the front side of the seat to extend in the width direction of the seat. The rear frame section 26 is a rear part of the frame body 20a, and located in the rear side of the seat to extend in the width direction of the seat. The paired side frame sections 24 are side parts of the frame body 20a, and each extend from the front to rear of the seat.

The frame body 20a has stiffness that is sufficient to maintain its generally rectangular shape (shape that follows the geometry of the frame member 4F) even when the occupant is seated (see FIGS. 3 and 4). In the present embodiment, each side frame section 24 has a core section CM and a resin section RM, and the front frame section 22 and the rear frame section 26 each have a core section CM (see FIGS. 3 and 4). The core section CM is a rod member that is routed in a shape which follows the geometry of the frame member 4F, and may be made of various types of metals (such as magnesium) or hard resin having desired stiffness. The resin section RM is a covering layer that is formed around the core section CM (see FIG. 4). The resin section RM may be provided almost throughout the total length of the side frame section 24 (region except a position at which the engagement section 31 is formed). Materials of the resin section RM may include thermoplastic resins (polypropylene, vinyl chloride resin, polyethylene) and thermosetting resins (phenolic resin, melamine resin, epoxy resin, urea resin), for example. Maleate modified polypropylene has affinity for various types of metals (such as magnesium), and hardly fall off the various types of metals. Therefore, in the present embodiment, the resin section RM that is made of the maleate modified polypropylene is preferably used.

Next, the supporting section will be described. The sheet body 20b (one example of the supporting section) is a member (single sheet member, for example) that is able to support the cushioning material 4P (see FIG. 2). The type of the sheet body 20b is not limited particularly; however, it may include fabric (woven, knit, nonwoven), leather (natural, synthetic), and a net member (a member in which fibers are woven in a net-like structure). The sheet body 20b according to the present embodiment is formed of single fabric, and may be secured to the frame body 20a (that has a space) (see FIGS. 2 and 3).

Next, the first parts and the second part will be described. In the present embodiment, the first parts 41 and the second part 42 may be formed on the rear frame section 26 in a row (see FIGS. 3 and 4). The first parts 41 are abutted against and engaged with the rear portion of the frame member 4F (rear frame 16). The second part 42 is a part to which the edge of the upholstery 4S (attaching member 17) is attached. In the present embodiment, the first parts 41 are formed at both sides of the rear frame section 26, and the second part 42 is formed at the center of the rear frame section 26. Each first part 41 may be formed by curving (deforming) a portion of the rear frame section 26 such that the first part 41 curves from the upper side to the lower side along the cross section of the rear frame 16 (circular shape), i.e., such that the first part curves from the upper side to the lower side so as to conform to the outer periphery of the rear frame 16.

The second part 42 is formed by curving the center portion of the rear frame section 26 such that the second part 42 curves from the lower side to the upper side (curved in the opposite direction from the first part 41) along the cross section of the rear frame 16 (circular shape), i.e., such that the second part 42 curves from the lower side to the upper side so as to conform to the outer periphery of the rear frame 16. The second part 42 forms the front edge of the center of the rear frame section 26 to protrude toward the center of the frame body 20a. In the present embodiment, during the formation of the second part 42, parts (temporary first parts 41) that are curved from the upper side to the lower side along the cross section of the rear frame 16 (circular shape) are formed. These parts are formed so as to be abutted against the rear frame 16, and thus the multiple first part 41s are formed.

Next, the engagement sections will be described. Each engagement section 31 is a generally crank-like member, and may be formed in an intermediate section of the side frame section 24 (see FIGS. 2 and 3). The material of the engagement section 31 is not limited particularly; however, it is usually the same material as that of the core section CM (stiff material). In the present embodiment, the engagement sections 31 are fitted to the intermediate sections (metal sections) of the side frame sections 24. At this time, the engagement sections 31 are relatively firmly fixed to the exposed core sections CM by welding or the like. Each engagement section 31 protrudes laterally outward from the frame body 20a (so as to cross the side frame 14), and thus made engageable with the frame member 4F.

Next, work for assembling the seat will be described. With reference to FIG. 2 to FIG. 4, the cushioning material 4P is installed on the frame member 4F via the support member 20. In the present embodiment, while the support member 20 is disposed in the frame member 4F, the engagement sections 31 are engaged with the side frame sections 24 (see FIGS. 3 and 4). Then, the front frame section 22 is inserted into the lugs 13, and the rear frame section 26 is engaged with the rear frame 16. In the present embodiment, the multiple first parts 41 are abutted against and engaged with the rear frame 16. At this time, the multiple first parts 41 are engaged (relatively firmly engaged) with the rear frame 16 so as to extend from the side (seating side), at which the cushioning material 4P is arranged, to the back side of the frame member 4F.

Next, the cushioning material 4P is covered with the upholstery 4S, and then the edge of the upholstery 4S (attaching members 17) is engaged with the support member 20 (see FIGS. 4 and 5). In the present embodiment, the edge of the upholstery 4S is guided from the side, at which the cushioning material 4P is arranged, to the back side of the rear frame 16. Then, the edge of the upholstery 4S is guided from the back side of the rear frame 16 and engaged with the second part 42 (part that is not a seating section). Because the second part 42 protrudes toward the center of the seat, the edge of the upholstery 4S is engaged with the second part 42 relatively easily. Then, the edge of the upholstery 4S that is arranged so as to surround the rear frame 16 is engaged with the second part 42.

In the seat structure of this type, the edge of the upholstery 4S may be pulled to the seating side due to, for example, a seating action of the occupant (see FIG. 4). In the present embodiment, the edge of the upholstery 4S that is arranged so as to surround the rear frame 16 is engaged with the second part 42. Thus, the second part 42 deforms in a direction toward the rear frame 16 (deflects in the direction of an arrow F1 in FIG. 4) due to, for example, tension of the upholstery 4S, and therefore the second part 42 is more firmly engaged with the rear frame 16. According to the present embodiment, the edge of the upholstery 4S is prevented from falling out of the second part 42 as much as possible (i.e., the structure allows the edge of the upholstery 4S to be stably attached to the second part 42). The deflection of the second part 42 stops when the second part 42 abuts against the rear frame 16. Accordingly, excessive deflection of the second part 42 is prevented by the rear frame 16, and therefore, generation of noise due to the excessive deflection is minimized.

As described above, in the present embodiment, because the attaching members 17 are engaged with the second part 42 (a part that is not the seating section), the edge of the upholstery 4S is engaged with the support member 20 with minimum reduction in seating comfort of the support member 20. As a result, according to the present embodiment, it is possible to attach the upholstery 4S to the support member 20 while maintaining good seating comfort as much as possible. In addition, the edge of the upholstery 4S that is arranged so as to surround the rear frame 16 is engaged with the second part 42 (the edge of the upholstery 4S is attached to the second part 42 with high stability). Because the upholstery 4S is attached to the second part 42 (a part that is not the seating section and that is a rear side portion of the support member), an amount by which the upholstery 4S is drawn onto the back side of the vehicle seat 2 is reduced (material cost is reduced by reducing the length of the upholstery 4S). Furthermore, in the present embodiment, the support member 20 is stably installed onto the frame member 4F with the multiple first parts 41. In the present embodiment, the sheet body 20b is secured in advance to the frame body 20a under tension (under uniform tension). Thus, in the assembly work described above, time and effort for applying tension to the sheet body 20b are saved. The support member 20 according to the present embodiment is a member which supports the cushioning material 4P and to which the upholstery 4S is attached. Therefore, another member to which the upholstery 4S is attached is no longer necessary, which suppresses increases in the number of seat parts.

The vehicle seat according to the invention is not limited to the one in the embodiment described above, but may be implemented in various other embodiments.

(1) In the present embodiment, the seat cushion 4 is described as one example of seat components. However, the structure according to the present embodiment may be applied to various seat components such as a seat back.
(2) In the present embodiment, a plurality of the first parts 41 and the second part 42 are formed in the rear frame section 26; however, the positions and numbers of these parts are not particularly limited. That is, the first parts 41 and the second part 42 may be formed in at least one of the front frame section 22, the side frame sections 24, and the rear frame section 26. In addition, the number of the first parts 41 and the number of the second parts 42 are not particularly limited (may be one, or two or more).
(3) The shape of the support member 20 according to the present embodiment is just one example, and may be changed as needed depending on the shapes of the frame member 4F and the cushioning material 4P. For example, each of paired side frame sections may be formed in a shape obtained by successively connecting multiple “S” shapes (another example of the supporting section) to support the cushioning material (structure that no longer requires the sheet body).
(4) In the present embodiment, one example of the attaching member (J-shaped resin member) is described; however, the present embodiment is not intended to limit the structure of the attaching member.

While the invention has been described with reference to example embodiments thereof, it is to be understood that the invention is not limited to the example described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A vehicle seat comprising:
upholstery that covers a seat;
a frame member that constitutes a seat framework;
a cushioning material that is placed on the frame member to constitute a seat exterior and elastically support an occupant; and
a support member which is a frame body, and via which the cushioning material is attached to the frame member, wherein
the cushioning material is covered with the upholstery, an edge of the upholstery is brought to a first side of the frame member that is different from a second side of the frame member, at which the cushioning material is arranged, and the edge is engaged with the support member,
the support member includes a supporting section that is disposed at a center of the frame member and is configured to support the cushioning material, a first part that is configured to abut against the frame member to be engaged with the frame member, and a second part to which the edge of the upholstery is attached, and
the first part and the second part are formed at one side of the support member in a row, the first part is formed by bending a portion of the one side of the support member so as to curve toward the first side of the frame member, the second part is formed by bending another portion of the one side of the support member so as to curve in an opposite direction from the first part and so as to protrude toward the center of the frame member.

2. The vehicle seat according to claim 1, wherein
the upholstery is engaged with the second part of the support member, and the first part of the support member is engaged with the frame member.

3. The vehicle seat according to claim 1, wherein
the support member has a plurality of the first parts.

4. The vehicle seat according to claim 3, wherein
the support member has a plurality of the second parts.

5. The vehicle seat according to claim 1, wherein
an attaching member is provided at a rear edge of the upholstery, and the upholstery is attached to the support member via the attaching member.

6. The vehicle seat according to claim 5, wherein
the attaching member is formed by forming a planar resin member into a predetermined shape.

7. The vehicle seat according to claim 6, wherein
the attaching member has a J-shape in cross section.
